(19) United States
(12) Patent Application Publication
(10) Pub. No.: US 2007/0062823 A1
(43) Pub. Date: Mar. 22, 2007

(54) WRAPPER FOR PAINTING DEVICES

(75) Inventor: John Anderson, Moraga, CA (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: THE LAZY JOE PAINT WRAPPER COMPANY, Moraga, CA (US)

(21) Appl. No.: 11/532,343

(22) Filed: Sep. 15, 2006

Related U.S. Application Data
(60) Provisional application No. 60/717,986, filed on Sep. 16, 2005.

(51) Int. Cl. B44D 3/04

(52) U.S. Cl. 206/1.8

(57) ABSTRACT

A wrapper and protective enclosure for a painting device includes a generally flexible enclosure forming a cavity having an opening for providing access to the cavity. The cavity is configured in size and shape to hold and store a painting device such as a brush, roller, tray or the like. The generally flexible enclosure is a multilayered material including at least one layer which provides a generally vapor proof barrier.

### FIELD OF THE INVENTION

The present invention relates to protective and storage wrappers for painting devices such as paint brushes, paint rollers and the like.

### BACKGROUND INFORMATION

Painting is a centuries old technique that is as popular today as ever. While there exists a myriad of painting apparatuses and accessories, the most common method and device for painting is the paintbrush and paint roller. These devices are easy to use and, when used properly, produce excellent results.

While there have been many advances in paintbrush and paint roller materials and construction, the method of painting using paintbrushes and paint rollers has changed very little over the centuries. In particular, care must be taken to protect the paintbrushes (specifically the bristles) and paint rollers from damage and to prevent the paint from drying on the bristles and roller cover material.

Heretofore, painters have prevented the paint from accidentally drying on the paintbrushes and paint rollers by diligently cleaning the paintbrushes and paint rollers after each use. While this is a generally effective method, it suffers from several disadvantages. One disadvantage to this method is that it is very time consuming. To be effective, this technique must be consistently performed each time the user stops using the paintbrush and paint roller for an extended period of time. Depending on the type of paint being applied, this may require the paintbrushes and paint rollers to be cleaned prior to coffee and lunch breaks as well as at the end of the day.

Because of the time involved, painters often neglect cleaning their paintbrushes and paint rollers after each use, frequently resulting in the paintbrushes and paint rollers becoming damaged or destroyed. This is particularly problematic for commercial painters since high quality paintbrushes and paint rollers are quite expensive. Even when a painter is diligent, this process still is problematic because of the time lost due to cleaning the paintbrushes and paint rollers. For example, a commercial painting crew of five could each easily spend over a half hour a day cleaning and preparing their paintbrushes and paint rollers. All told, this amounts to over two and half hours of unproductive downtime per day and over 12.5 hours of unproductive downtime a week. Furthermore, many do-it-yourselfers find that they are unable to clean their brushes and rollers properly and therefore do not undertake the task and instead throw away the painting device after each use.

Additionally, the repetitive cleaning of the paintbrushes and paint rollers often damages the paintbrushes and paint rollers. Improper use of cleaning solvents can also damage or hasten the deterioration of the paintbrush bristles and roller cover. For example, hot water can loosen the adhesive that holds certain paintbrush bristles in place, and water can also cause a wooden paintbrush handle to swell and loosen from the ferrule. Denatured alcohol, often used for cleaning brushes, can also damage the bristles over time. Leaving a paintbrush in a solvent solution to soak will cause the bristles to become bent and frayed. Furthermore, solvents often used in clean up are toxic to the environment and the user so the less frequently they are used, the better. Different types of paint may require different solvents or the use of multiple solvents (e.g. both water and mineral spirits. In an effort to reduce the time to clean the paintbrushes and paint rollers, painters often press and pull on paintbrushes and paint rollers while cleaning them. This bends and damages the bristles of paintbrushes and the naps of paint rollers.

There currently exists a paintbrush and paint roller storage system whose purpose is simply to keep paintbrushes and paint rollers moist without cleaning them that utilizes a hinged, two-part molded plastic box and includes a foam gasket disposed about the perimeter of the storage box between the two parts. Unfortunately, this device requires the user to moisten the foam in order to properly seal the box. Introducing water near the paintbrush and paint roller is undesirable, especially with certain types of paints. Moreover, the foam must be replaced periodically. This is problematic because it requires the user to have a supply of foam pieces on hand.

Another problem associated with the known storage boxes is that they are quite bulky and expensive. This is problematic given the number of paintbrushes and paint rollers a typical painting crew has at any one time.

Accordingly, what is needed is a device which easily and quickly protects and stores painting devices such as, but not limited to paintbrushes and paint rollers from damage in a minimum amount of time. The device should reduce the need to clean paintbrushes and paint rollers and allow the paintbrushes and paint rollers to sit after being used without cleaning for an extended period of time, thereby decreasing the amount of downtime. Additionally, the device should be inexpensive, easily stored both when in use and when not in use, should not require any extra pieces that must be replaced, and should allow the user to take their painting devices with them or pack them easily and in a small area.

### SUMMARY OF THE INVENTION

The invention features a protective wrapper for a painting device, comprising a generally flexible enclosure forming a cavity and having an opening for providing access to the cavity. The cavity is configured to receive a painting device such as a brush, roller or paint tray. The opening includes a closure device operational for closing the opening. The generally flexible enclosure is typically and preferably comprised of a multi-layered material, at least one layer of which provides a generally vapor proof barrier. In the preferred embodiment, the vapor proof barrier is a metallized layer such as an aluminum layer.

The protective wrapper for a painting device according to the present invention is preferably made from a multilayered, laminated material. The laminated material includes an outer layer of a polyester film; a middle metallized layer; and an inner layer of a polyethylene film.

The closure devices for the opening typically consist of either a zipper device; a two part zip lock device; a hook and loop closure; an adhesive; and a self adhesive closure.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1 is perspective front view of one embodiment of the wrapper for painting devices according to the present invention;

FIG. 2 is a plan front view of another embodiment of the wrapper for painting devices according to the present invention shown with a brush; and

FIG. 3 is a top view of yet another embodiment of the wrapper for painting devices according to the present invention shown with a roller.

### DETAILED DESCRIPTION OF THE PREFERRED EMBODIMENTS

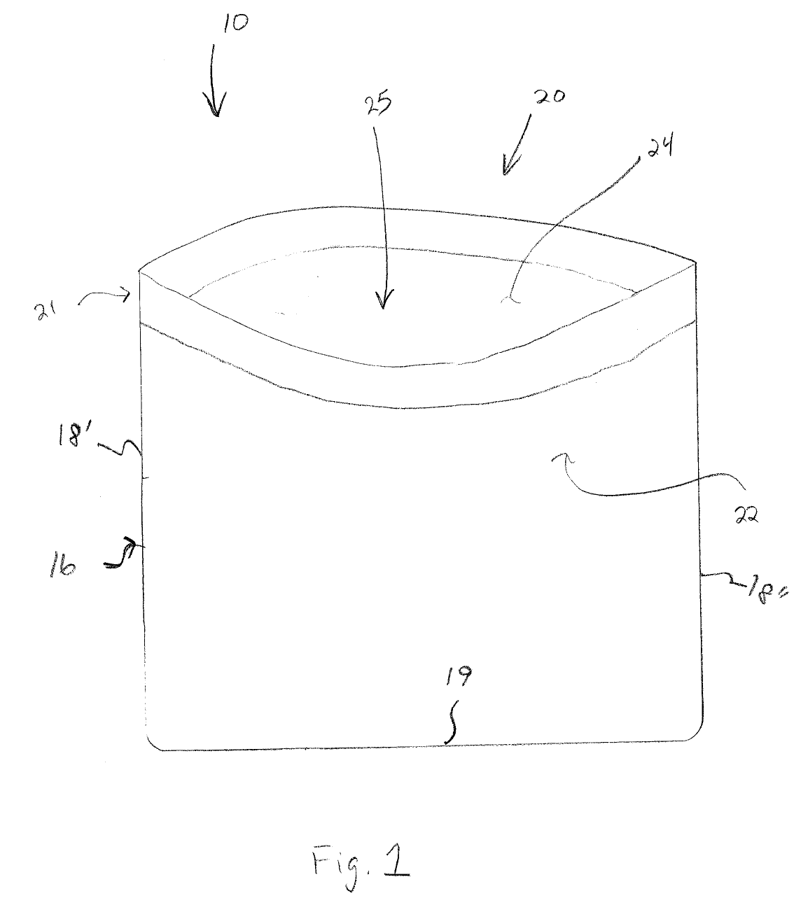

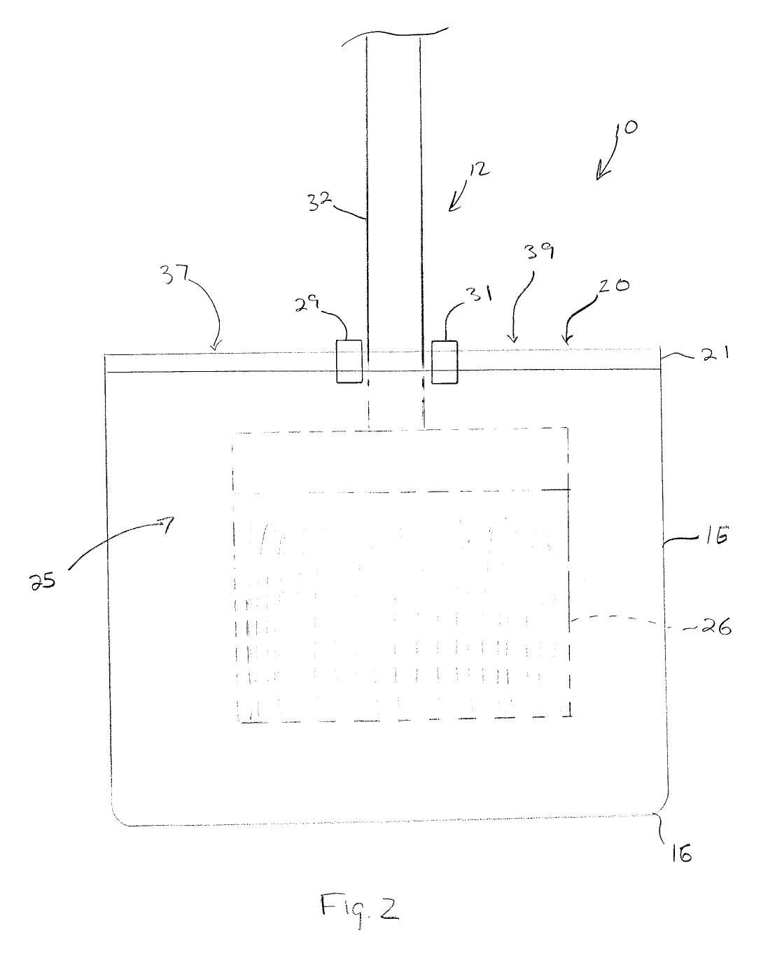

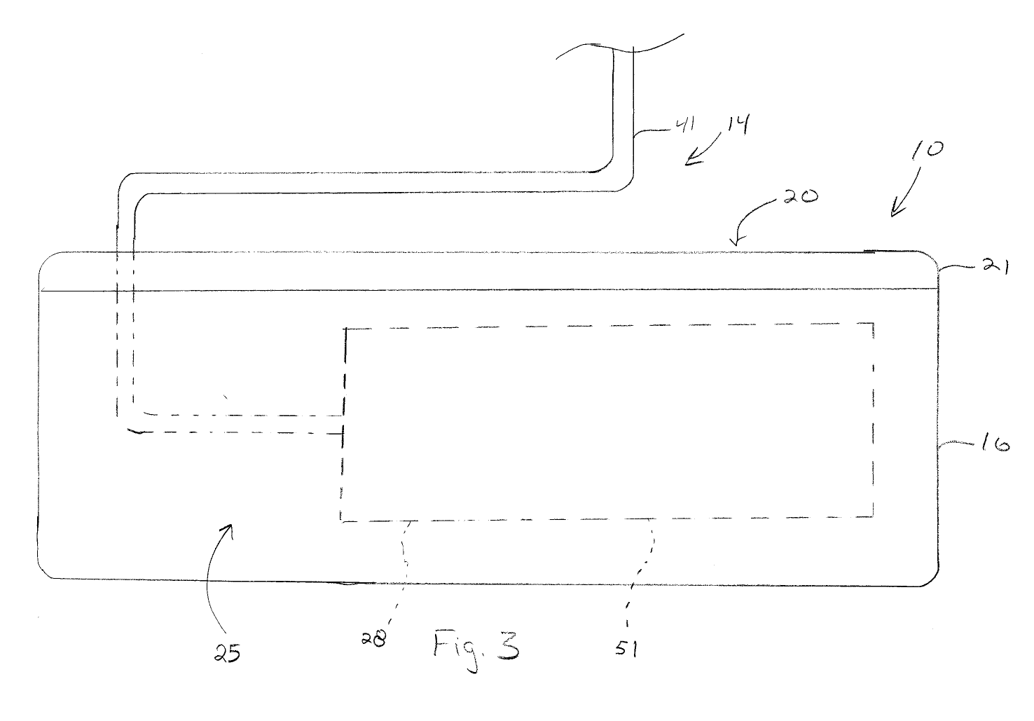

According to one embodiment, the present invention features a wrapper for painting devices 10, FIG. 1, for storing and protecting a paint brush 12 FIG. 2; a wrapper for storing and protecting a paint roller itself 14, FIG. 3; and a wrapper for storing or protecting a jumbo or large sized paint roller mounted on a paint roller device, or any other similar device (such as a paint roller paint tray with roller therein) which can fit within a cavity 25 formed therein.

In the preferred embodiment, the protection device 10, FIG. 1, is used with paint and painting devices although this is not a limitation of the present invention. Those skilled in the art will recognize that the protection device 10 may be used with materials such as, but not limited to, asphalt, solvents, varnishes, polymers, art supplies, marine products, and the like.

The protection device 10 includes a body 16 having typically two sides 18′ and 18″, and a bottom 19, at least one opening 20 with a seal 21 forming a cavity 25. In the preferred embodiment, the body 16 includes a first and a second portion 22, 24 (for example, but not limited to, a front and a rear half) which are secured to each other along the sides and bottom regions 18 and 19 respectively by any method known to those skilled in the art such as, but not limited to, heat sealing, thermal sealing, adhesive, infrared or ultrasonic welding or the like to form the cavity 25.

The seal 21 includes any device known to those skilled in the art for substantially closing the opening 20. In the preferred embodiment, the seal 21 includes a two part zip-lock seal, a hook and loop type connection, a self-sealable material, or an adhesive, as well as mechanical seals such as, but not limited to, zipper-types seals, and the like.

The body 16 is made from any material that is vapor resistant. As used herein, the term “vapor resistant” means that the material contained within the protection device 10 substantially does not degrade within a specified time period. This does not mean that no degradation can occur, but rather that the amount of degradation must be substantially inconsequential. While the time period may vary, in the preferred embodiment the time period is at least 24 hours and may extend upwards of a week or more.

The body material 16 should also be durable such that it is resistant to tearing during normal use including both commercial and non-commercial use. Moreover, the body material 16 must also be relatively stiff. As will be explained in greater detail below, the body 16 must be sufficiently stiff to prevent damage to the brush 12, FIG. 2, (in particular the bristles 26) or roller 14, FIG. 3, (in particular the nap 28) when inserting and removing the brush 12 or roller 14 from the protective device 10. Additionally, the body 16 must be sufficiently stiff or rigid such that the brush 12 or roller 14 can be easily inserted/removed within the protective device without causing the protective device to wrinkle-up. Finally, the body 16 must be sufficiently stiff or rigid such that the brush 12 or roller 14 is held in place within the protective device 10.

In the preferred embodiment, the body material 16 includes a laminate material. For illustrative purposes only, and not a limitation of the present invention unless specifically claimed as such, the body material 16 includes a polyester film on the outside for strength and puncture resistance; a middle layer composed of aluminum foil which provides the moisture and vapor barrier protection; and an inner layer of polyethylene film which is used to provide the ability to heat seal the side and bottom edges and to which the zip lock or other closure if attached. Other materials include metalized polyethylene terephthalate (PET) and polyethylene (PE) and a metalized PET/foil/PE laminate such as VF60 sold by LPS Industries, Inc. Additionally, the foil layer (preferably aluminum or the like) further increases the vapor barrier properties and provides additional stiffness. Finally, the laminate material also reflects light. This is beneficial because it aids in preventing the paint from reacting with sunlight and drying out.

The known traditional clear or opaque plastic bags have been tested but have been found unsatisfactory for several reasons. Firstly, the plastic material has been found to be not durable enough and is prone to tearing, especially during commercial use. Additionally, traditional plastic bags tend to adhere to the brush 12 and roller 14, damaging the bristles 26 and the nap 28. Moreover, it has been found that inserting brushes 12 and rollers 14 into a traditional bag is difficult because the bags tend to “wrinkle up” due to the lack of stiffness. Finally, the lack of stiffness or rigidity causes the brushes 12 and rollers 14 to move around undesirably within the protective device 10.

Referring specifically to FIG. 2, a protective device 10 is shown intended for use with a brush 12. In this embodiment, the protective device 10 is generally rectangular in shape and is approximately 6.5 inches by approximately 6.87 inches, although this is not a limitation of the present invention. A protective device 10 according to these illustrative dimensions forms an opening 20 and a cavity 25 that will accommodate up to approximately a 6-inch brush 12.

In this embodiment, the handle 32 of the brush 12 is partially disposed within the cavity 25 and extends through the opening 20. Accordingly, the seal 21 forms first and second sections 37, 39 disposed on either side of the handle 32. In the embodiment wherein the seal 21 includes a zipper-type seal, it is preferably to have at least two zippers 29, 31 although this is not a limitation of the present invention.

Referring specifically to FIG. 3, a protective device 10 is shown intended for use with a roller 14. In the preferred embodiment, the protective device 10 has a generally rectangular shape and is approximately 6.5 inches by approximately 13 inches. A protective device 10 according to this illustrative example can accommodate up to approximately a 9-inch roller. The roller cover 51 is disposed within the cavity 25 of the protective device and the frame 41 of the roller 14 is partially disposed within the cavity 25.

Alternatively, the protective device 10 may be approximately 22.5 inches by approximately 10 inches to accommodate up to approximately an 18-inch roller commonly used by commercial painters. As one of ordinary skill in the art can readily discern, the protective device 10 can be of any size of shape to accommodate the object or item to be contained. In addition, as one of skill in the art will readily recognize, the thickness of weight of the enclosure material can be increased, if desired, as the enclosure get larger in size. An example of a “thicker”, more rigid and heavier gauge wrapper or protective device 10 is a material such as VF42 sold by LPS Industries, Inc.

Accordingly, the protective device 10, FIG. 1, as described herein provides an easy method and device for protecting a brush, roller, or the like. In practice, whenever the painter intends to stop using the brush/roller for a period of time (which can be anywhere from a few hours to overnight to one or more days, to one or more weeks), the user simply opens the protective device 10, places the brush/roller into the cavity 25, and seals the opening 20 using the seal 21. Once the brush/roller is inserted within the protective device 10, the protective device 10 substantially prevents the material (paint, asphalt, stain, varnish or the like) from drying on the brush/roller and from contaminating the area around the device. It also allows the painting device to be moved and taken off one job to another or to be stored in a user's vehicle or tool box overnight or over the weekend. As explained above, for a typical crew of professional painters, the present invention can save approximately 2.5 hours or more of total wasted time a day due to cleaning of brushes/roller. Additionally, the brush/roller is protected from the environment (for example, from contact with dirt due to wind or accidental dropping). The present invention also reduces the need to clean the brush/roller/tray, thereby extending the life of the brush/roller especially from damage caused by improper or excessive cleaning and the introduction of foreign matter or debris onto the brush/roller or into the paint tray and minimizing the effects of the use of toxic solvents to clean the painting devices. The stiffness/rigidity of the present invention also facilitates insertion and removal by preventing the protective device 10 from wrinkling-up.

As mentioned above, the present invention is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention.

What is claimed is:

1. A protective wrapper for a painting device, comprising:
a generally flexible enclosure forming a cavity and having an opening for providing access to said cavity, said cavity configured to receive a painting device, said opening including a closure device operational for closing said opening, said generally flexible enclosure comprising a multi-layered material, at least one layer of said multilayered material providing a generally vapor proof barrier.

2. The protective wrapper for a painting device of claim 1 wherein said vapor proof barrier is a metallized layer.

3. The protective wrapper for a painting device of claim 2 wherein said metallized layer is an aluminum layer.

4. The protective wrapper for a painting device of claim 1 wherein said multilayered material is a laminated material.

5. The protective wrapper for a painting device of claim 4 wherein said laminated material includes an outer layer of a polyester film; a middle metallized layer; and an inner layer of a polyethylene film.

6. The protective wrapper for a painting device of claim 1 wherein said closure device is selected from the group consisting of a zipper device; a two part zip lock device; a hook and loop closure; an adhesive; and a self adhesive closure.

7. The protective wrapper for a painting device of claim 1 wherein said painting device is selected from the group consisting of a brush, a roller, a paint tray and roller and a spray device.

8. A protective wrapper for a painting device, comprising:
a generally flexible enclosure forming a cavity and having an opening for providing access to said cavity, said cavity configured to receive a painting device, said opening including a closure device operational for closing said opening, said generally flexible enclosure comprising a multi-layered laminated material, at least one layer of said multilayered material, wherein said laminated material includes an outer layer of a polyester film, a middle metallized layer, and an inner layer of a polyethylene film, wherein said middle metallized layer providing a generally vapor proof barrier.

9. The protective wrapper for a painting device of claim 1 wherein said closure device is selected from the group consisting of a zipper device; a two part zip lock device; a hook and loop closure; an adhesive; and a self adhesive closure.

10. The protective wrapper for a painting device of claim 1 wherein said painting device is selected from the group consisting of a brush, a roller, a paint tray and roller and a spray device.
